(19) United States
(12) Patent Application Publication
(10) Pub. No.: US 2005/0126881 A1
(43) Pub. Date: Jun. 16, 2005

(54) Counter/tabletop alignment note feeder with plunger

(76) Inventors: Richard J. Iannello, Sebastopol, CA (US); James K. Bullock, Las Vegas, NV (US); Gwen D. Mathis, Las Vegas, NV (US)

Correspondence Address: David B. Abel, Esq.;Squire, Sanders & Dempsey, L.L.P., 14th Floor, 801 S. Figueroa Street, Los Angeles, CA, 90017, US

(21) Appl. No.: 10/958,959

(22) Filed: Oct. 4, 2004

Related U.S. Application Data
(63) Continuation-in-part of application No. 10/863,059, filed on Jun. 7, 2004.
Application No. 10/863,059 is a continuation of application No. 10/081,756, filed on Feb. 20, 2002, now Pat. No. 6,745,887.

(51) Int. Cl. G07F 7/04

(52) U.S. Cl. 194/206

(57) ABSTRACT

A bill acceptor assembly for accepting bills, vouchers, scrip, tickets and/or currency at a gaming table. The bill acceptor assembly includes a note feeder capable of accepting a stack of individual notes from the top side of a table and providing the stack of notes to a validator assembly located underneath the table. The note feeder has a cavity configured to receive at least one note, an opening within the cavity to allow the at least one note to pass through the opening, and an escrow chamber to temporarily store the stack of notes passed through the opening. A plunger may be used to push the at least one note within the cavity through the opening and into the escrow chamber. A transportation system is provided to pass note within the escrow chamber to a validator assembly.

### BACKGROUND OF THE INVENTION

1. Related Applications

This application is a Continuation-In-Part of U.S. application Ser. No. 10/863,059 filed on Jun. 7, 2004 which is a Continuation of U.S. application Ser. No. 10/081,756, filed Feb. 20, 2002, entitled Gaming Table Validator Assembly, now U.S. Pat. No. 6,745,887, the applications for which are hereby incorporated by reference.

2. Field of Invention

This invention is directed to a note feeder adapted to receive one or more notes from the top side of a table and provide the notes to a validator assembly located underneath the table. In particular, the bulk note feeder is adapted to provide each of the notes to the validator assembly along a predetermined path and selected orientation.

3. General Background and State of the Art

Conventional gaming tables located in casinos are generally used to play games such as blackjack, poker, roulette, baccarat, and craps. The table may have an outer periphery containing a plurality of player locations and a dealer's location located generally opposite the player locations. From the dealer's location, the dealer controls the pace and operation of the game including for example dealing the cards, paying winning wagers and collecting losing wagers.

A dealer's responsibilities also include exchanging currency or notes received from a player for casino chips. Generally, when a player wants to exchange currency or notes for chips at the gaming table, the player gives the currency or notes to the dealer. Notes, as used herein, can include local and foreign currency, casino scrip, and casino issued tickets. The dealer counts out and then spreads the currency or notes on the playing surface of the gaming table. The dealer is sometimes required to notify a Pit Boss that the dealer is exchanging currency or notes. After receiving an approval from the Pit Boss, the dealer accepts the currency or notes and deposits them into a slot accessible from the playing surface of the gaming table. The slot leads to a channel for transporting the currency or notes from the slot to a cash box located below the playing surface. A plate may be used to push the currency or notes into the slot and ensure that the currency or notes properly fall into the cash box.

The revenues received on the gaming tables are a significant source of income for a casino. Accordingly, the high volume of currency or notes exchanged invites the risks of receiving counterfeit currency or notes. Unlike slot machines, wherein the implementation of integrated bill acceptors in the slot machines has diminished the casinos' risk of receiving counterfeit currency, most gaming tables remain susceptible to this risk. Due to the increased sophistication of counterfeiters and the increasing difficulties in discriminating between authentic and counterfeit currency, the manual or dealer inspection method of accepting currency on gaming tables is inadequate to protect casinos from currency fraud. Also, as the use of casino scrip and casino tickets increases, there is a risk that these forms of revenue could be compromised or counterfeited. Accurate accounting of these alternative forms of notes may require that they be validated upon receipt.

A few attempts have been made to patent the use of a bill acceptor assembly on electronic gaming tables. For example, U.S. Pat. No. 5,775,993 (“the '993 patent”) issued to Fentz et al. discloses a bill acceptor assembly mounted at each player station located around an electronic roulette wheel. Similarly, in U.S. Pat. No. 5,588,650 (“the '650 patent”), each player console located around an automated roulette wheel includes a bill acceptor. In both of these patents an individual as opposed to a computer directs the game. A player can insert money into the bill acceptor to earn credits at any time, even though the player may not be able to place a bet until the next betting period. Yet, both the '993 patent and the '650 patent have two fundamental flaws. First, both patents use traditional single-feed bill acceptors where the player must insert one note at a time into the bill acceptor. The bill acceptors in the '993 patent and the '650 patent are not designed to accept multiple notes at one time. At a gaming table, players may start their betting with a large sum of money which, in the configuration of the '993 or '650 patents, would require each player to feed each note one at a time into the bill acceptor. The effort involved in feeding each note can be time consuming and frustrating, and even more so if the bill acceptor does not accept every note on the first feeding attempt.

Second, incorporating a bill acceptor into a computerized gaming table does not involve the same difficulties as incorporating a bill acceptor into a conventional gaming table operated by an individual. On the computerized gaming table, a computer using pre-programmed software manages each player's credits, operates the game, calculates and pays out all winnings, and collects any losing wagers. No casino tokens or notes are dispensed until a player cashes out. On the other hand, a gaming table operator has to do all of the functions by himself or herself. In addition, the operator is given the responsibility of watching each player to ensure that he/she does not cheat. Neither the '993 patent nor the '650 patent explain or address the many concerns of how to incorporate the bill acceptor into a gaming table operated by an individual. For example, neither patent discloses how the operator would know how much money has been inserted into the bill acceptor. This disconnect in information would prevent the operator from knowing how many tokens to give back to the player.

Accordingly, a system for accepting valid currency and rejecting counterfeit currency on a conventional gaming table would be beneficial to the gaming industry. Such a system would increase the casino's profitability by decreasing the amount of counterfeit currency it may receive. Moreover, a bill acceptor capable of accepting and validating a stack of notes would significantly decrease the delay involved in feeding one note at a time into the bill acceptor.

Modern day cash exchange transactions have become much more efficient with the invention of automated bill acceptors as described previously. In general, bill acceptors have increased the efficiency, accuracy and reliability of the intake of such transactions. Bill acceptors are now utilized in a variety of different forums, including parking booths, toll booths, vending machines and, more recently, gambling venues.

In the gaming industry, a dealer has many tasks to perform while conducting his/her job. One of the tasks of a dealer is to insure that the notes received by players are properly deposited into a cash box typically located beneath the gaming table. With the advent of automated bill acceptors as described herein used in connection with gaming tables, the dealer will be responsible for insuring that the notes received from the players are fed to the bill acceptor and ultimately delivered to a secured cashbox. Inserting individual notes into a bill acceptor could distract the dealer away from other tasks. Minimizing the distraction of the dealer when inserting notes into a bill acceptor on a gaming table is thus desirable.

### SUMMARY OF THE INVENTION

This invention is directed to a note feeder assembly adapted to accept a stack of notes and pass the notes to a validator for authenticating, sorting, and stacking the notes. Due to the expansion of the types of currency and currency substitutes which are accepted by current bill acceptors, bills, vouchers, script, tickets and currency will be hereinafter collectively referred to as “notes.” The note feeder of the present invention includes a cavity configured to receive at least one note, an opening at the bottom of the cavity to allow the at least one note to pass to an escrow chamber to temporarily store the note or stack of notes passed through the opening. This invention also contemplates a plunger to push the at least one note within the cavity through the opening and into the escrow chamber. In addition, a transportation system is provided to pass the at least one note from the escrow chamber to a validator assembly. The escrow chamber may temporarily store the notes in a predetermined orientation so that the transportation system may sequentially pick each of the notes from the escrow chamber and deliver the notes to the validation assembly.

The cavity of the note feeder may be provided within a top surface of a gaming table near the dealer station. The cavity may be surrounded by edges which are raised above the top surface of the gaming table to prevent accidentally spilled liquids from entering the opening within the cavity. The raised edges may also allow the operator or dealer to locate the cavity by touch to minimize distracting the dealer. The escrow chamber of the note feeder and the validator assembly are preferably provided within or underneath the table. After placing a stack of notes into the cavity, a dealer may use the plunger to push the stack of notes through the opening of the bottom of the cavity. Once the notes pass through the opening, the notes move to the escrow chamber located underneath the table top so that the notes within the escrow chamber may be passed to the validator assembly.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a perspective view of a gaming table with an installed bill acceptor.

FIG. 2 is a representative cross sectional view of the bill acceptor and a cash box assembly.

FIG. 3 is a perspective of a mounting bracket for mounting the bill acceptor to the gaming table.

FIG. 4 is a perspective view of a cashbox housing and power assembly of the bill acceptor.

FIG. 5 is a perspective view of an alternative configuration for a bill acceptor and a bill guard installed on a gaming table.

FIG. 6 is a perspective view of another alternative embodiment of a bill acceptor for mounting on a gaming table.

FIG. 7 is a perspective view of a note feeder and a plunger.

FIG. 8 is a perspective view of the note feeder of FIG. 7 with the plunger inserted.

FIG. 9 is an exploded perspective view of the note feeder to be coupled with a transportation system.

FIG. 10 is a cross-sectional view of the note feeder and the transportation system of FIG. 9.

FIG. 11 is a partial, cross sectional view of components of the transportation system of FIG. 9.

### DETAILED DESCRIPTION OF PREFERRED EMBODIMENTS OF THE INVENTION

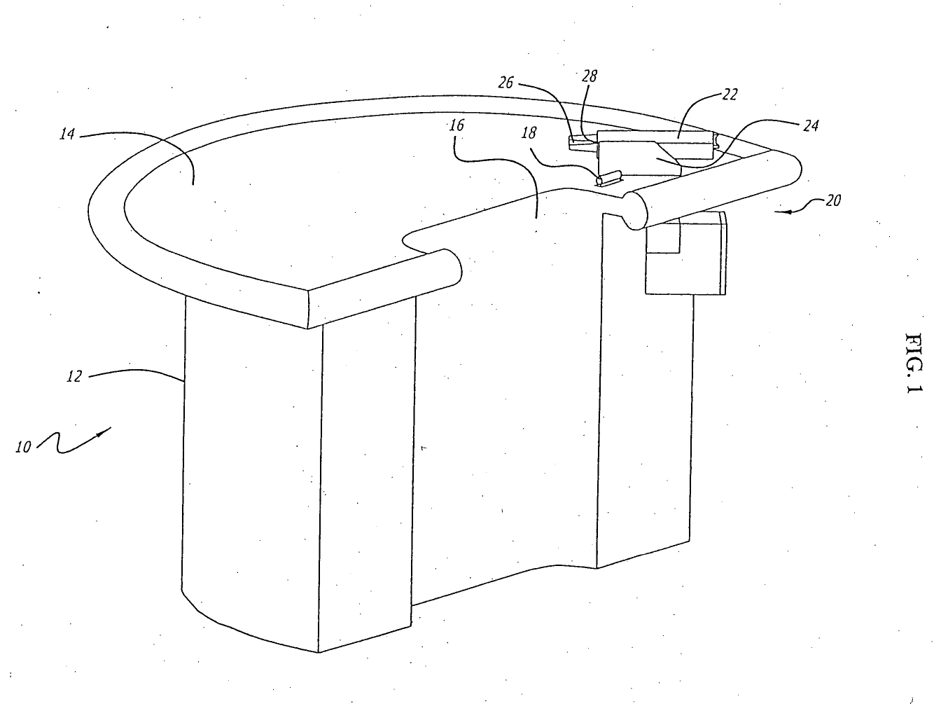

FIG. 1 provides a perspective view of a gaming table 10 having a base 12 and a playing surface 14. The gaming table 10 has a dealer station 16 opposed by semi-circularly arranged player positions. The gaming table 10 will normally have a drop slot 18, positioned proximate the dealer station 16, which defines a hole in the gaming table 10 and allows for notes to be deposited into a cash box contained proximate the base 12, or within the base. While a card type gaming table is depicted, the invention is applicable to other types of gaming tables.

As further illustrated in the exemplary embodiment of FIG. 1, a bill acceptor 20 is positioned on the playing surface 14 of the gaming table 10. The bill acceptor 20 includes a housing 22 and a mounting bracket 24 to secure the housing 22 to the gaming table 10. The housing 22 includes a bezel 26 upon which notes can be stacked and sequentially fed through a slot 28 into the bill acceptor 20. The slot 28 generally comprises an opening dimensioned to receive the notes.

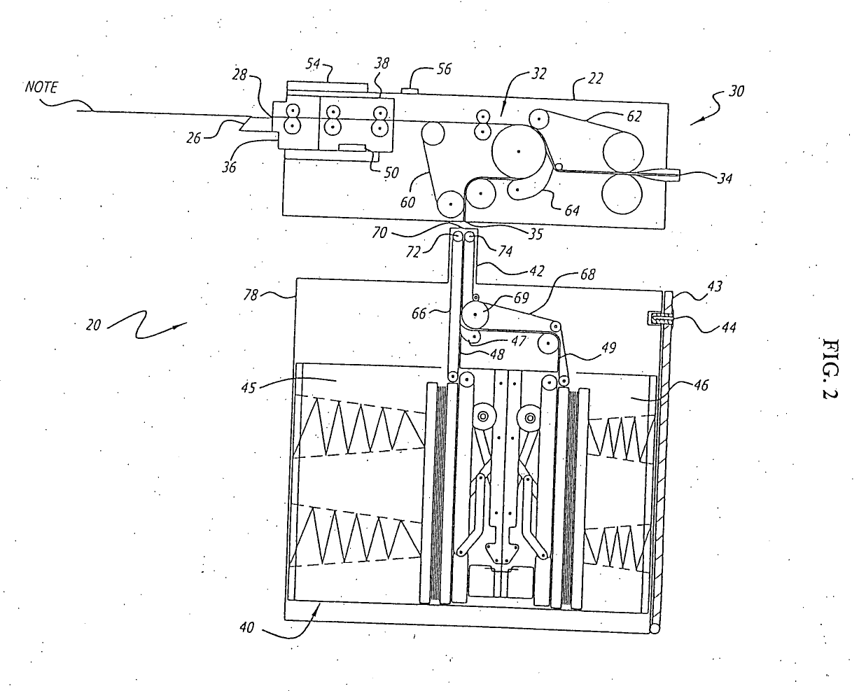

FIG. 2 depicts a cross-sectional view of the bill acceptor 20 and an associated cash box 40 removed from the gaming table 10 of FIG. 1. Within the bill acceptor 20, the notes are transported through a validator assembly 30 by a transportation assembly 32, as discussed below. A bill separator 36 may be located proximate the slot 28. The notes pass from the bill separator 36 through a bill discriminator 38 to determine if the notes are authentic. The bill acceptor 20 also includes, at an opposite end of the housing 22, a bill dispenser slot 34. In the event that the bill discriminator 38 determines that a note inserted into the validator assembly 30 is not authentic, the transportation assembly 32 passes the note through the housing 22 to the bill dispenser slot 34.

As illustrated, notes are to be inserted into the bill acceptor 20 through the slot 28. Notes rejected by the validator assembly 30 are ejected through the bill dispenser slot 34. Valid notes are deflected downward through a slot 35 located on the underside of the housing 22 which is to be positioned over the drop slot 18 of the gaming table 10. In an alternative embodiment, the notes are directed to a location along the back edge of the gaming table 10 to then be transported to the cash box 40.

A power assembly 42 draws the valid notes away from the validator assembly 30 and deposits them into the cash box 40, which is to be mounted below the playing surface 14 of the gaming table 10. The power assembly 42 also supplies power to and exchanges information with the validator assembly 30 through a power connector located on the underside of the housing 22 as discussed below. The cash box 40 is contained within a cash box housing 78 having a cash box door 43 and a door lock 44 to prevent unauthorized access to the contents of the cash box 40. The cash box 40 may simply be an open container having a slot in the top through which the notes are inserted. As depicted in FIG. 2 the cash box 40 receives and stacks the notes. While the cash box 40 may have a single stacker for all of the notes, it may be preferable to have two stacker sections as depicted, wherein first stacker section 45 receives and neatly stacks currency. A second stacker 46 can be used to stack a selected currency denomination or alternatively all non-currency notes accepted by the bill acceptor. As another alternative, the second stacker 46 could be used to store “fill slips” signifying additional chips being brought to the gaming table. Thus, the second stacker 46 could be used to store all documents, or all non-currency items, received by the bill acceptor. Accordingly, for this dual stacker cash box, the power assembly 42 will have a transport system and a deflector 47 to allow the notes to be directed to the appropriate stacker along a first transport path 48 or a second transport path 49.

The validator assembly 30 contains a circuit board mounted validator processor 50 which is also preferably connected to a central computer or server (not shown) of the casino. The validator processor 50 has various processing capabilities which are known in the art. Upon receipt of a note and determination of validity, a signal is sent to the casino processor or server signifying receipt as well as the denomination of the note. The value of the notes accepted by the validator assembly 30 can then be displayed on an LCD display 54.

There may be situations where some or all of the notes received are rejected from the validator assembly 30 even though it may be apparent to the dealer that the rejected notes are authentic. In this and other situations, the dealer may want to accept the notes in spite of the refusal of the validator assembly 30. To override the decision of the validator assembly 30, the dealer could activate an override input, such as an Accept button 56 which is electrically connected (not shown) to the validator processor 50. Pressing the Accept button 56 will force the validator assembly 30 to accept the notes and the transportation assembly 32 to transport the notes to the cash box 40. Software associated with the bill acceptor 20 can be provided to keep track of the number of notes received as a result of the dealer overriding the validator assembly 30.

If a player wants to place a bet with a dealer operating a casino game on the gaming table 10, casinos generally require the player to use the casino's own tokens to play. The player may already have casino tokens in possession or may give notes to the dealer who will exchange the notes for an equivalent value of casino tokens. To validate the notes received from the player, the dealer or player places the stack of notes on the bezel 26. The bill separator 36 pulls off one note at a time through the slot 28. The technology of bill separators is known in the art, which includes feeding devices such as printers, photocopiers, currency counters, and automated teller machines that feed one sheet of paper, such as a note, from a stack of paper or notes.

The notes are then pulled into the bill discriminator 38 by the transportation assembly 32. Because they are electrically connected to one another, the bill discriminator 38 can instruct the transportation assembly 32 to direct and transport validated notes into the cash box 40 and invalid notes to the bill dispenser slot 34. The transportation assembly 32 includes belts 60 and 62 that transport the note from the bill discriminator 38 to the deflector 64. Depending on the authenticity of the note processed, the bill discriminator 38 will send a signal to a deflector 64 which directs the pathway of the note through the validator assembly 30. If the note is authentic, the deflector 64 will remain in an initial position to direct the notes downwards towards the cash box 40. In the event the note is not authentic according to the bill discriminator 38, the deflector 64 moves from the initial position to a secondary position to deflect the note to an exit or horizontal pathway out of validator assembly 30.

It is understood that the transportation assembly 32 discussed above is an exemplary embodiment for illustration purposes only. Other transportation systems well known or apparent to one skilled in the art are to be included within the scope of the present invention. In addition, in an alternative embodiment, the slot 28 and the bill dispenser slot 34 may be the same.

As illustrated in the cross-sectional view of FIG. 2, the transportation assembly 32 transports valid notes past the deflector 64 to slot 35, which is positioned opposite a narrow extension of the power assembly 42, configured to extend up through the drop slot 18 of the gaming table 10. At the top of the narrow extension is a slit 70 into which the notes are directed. After entering the slit 70, the note passes between two wheels 72 and 74, driven by belts 66 and 68, respectively which draw the note down towards the cash box 40 and away from the validator assembly 30. The belt 66 extends down to the top of the cash box 40 to direct notes to the first stacker 45 of the cash box 40 if a deflector 47 is in an initial position according to the type of note. Belt 68, driven by a motor drive 69 and passing over or around various idler wheels, drives belt 66 and controls the direction of notes directed to the second stacker 46 of the cash box 40 if the deflector 47 moves to a second position.

The bill acceptor 20 may be composed of multiple modules that facilitate installation on a gaming table 10, including for example the mounting bracket 24, the validator assembly 30, and the cash box housing 78 which contains the power assembly 42 as well as the cash box 40. The validator assembly 30 can be an independent component and compact assembly, for example, about the width and length of two U.S. currency bills placed consecutively lengthwise. The mounting bracket 24 is adapted to receive and securely hold the validator assembly 30 to the gaming table 10.

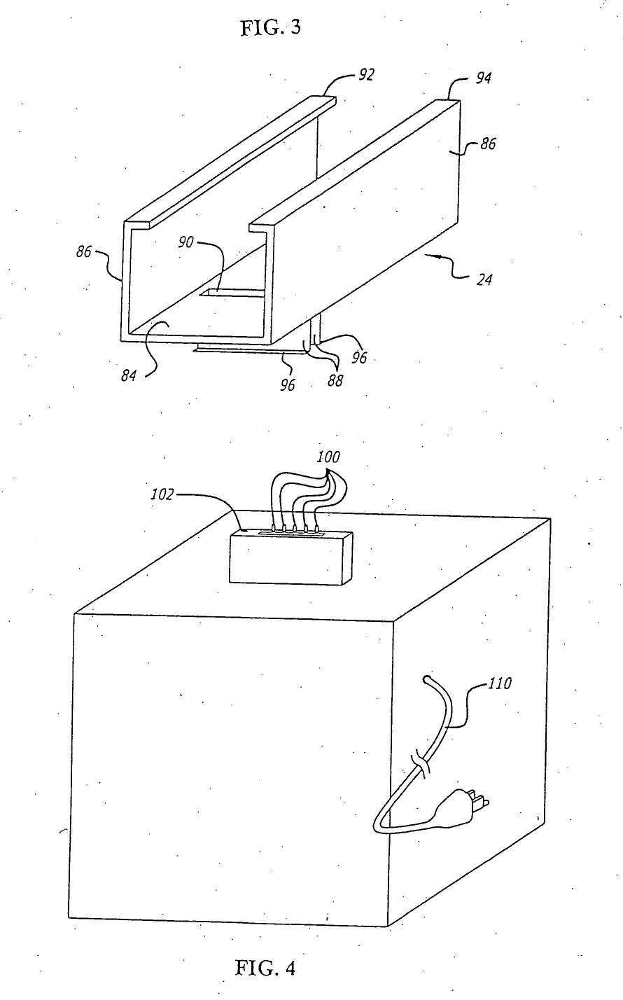

As illustrated in FIG. 3, the mounting bracket 24 may have a base plate 84 that is connected to two plates 86 extending upward and two plates 88 extending downward. The base plate 84 has an opening 90 that is similar in size to the opening of the drop slot 18. The upward plates 86, which rise upward from the base plate 84 and contain overhangs 92 and 94, secure the validator assembly 30 from the top, underside, and each side parallel to the length of the validator assembly 30. A locking mechanism may be provided on the validator assembly 30 so that it can mate and lock with a lock receiver to secure the validator assembly 30 to the mounting bracket 24.

The plates 88, which extend downward from the base plate 84, are parallel to the wider wall of the drop slot 18. The lower ends of the plates 88 extend down the full length of the drop slot 18. At the lower end, the plates 86 may include flanges 96 that clip to the underside of the gaming table 10. To install the mounting bracket 24, the plates 88 are inserted into and pushed through the drop slot 18. After the flanges 96 extend past the end of the drop slot 18, the flanges 96 grip onto the gaming table 10, preventing the removal of the mounting bracket 24. To remove the mounting bracket 24 from the gaming table 10, the flanges 96 must be squeezed together from below the gaming table 10.

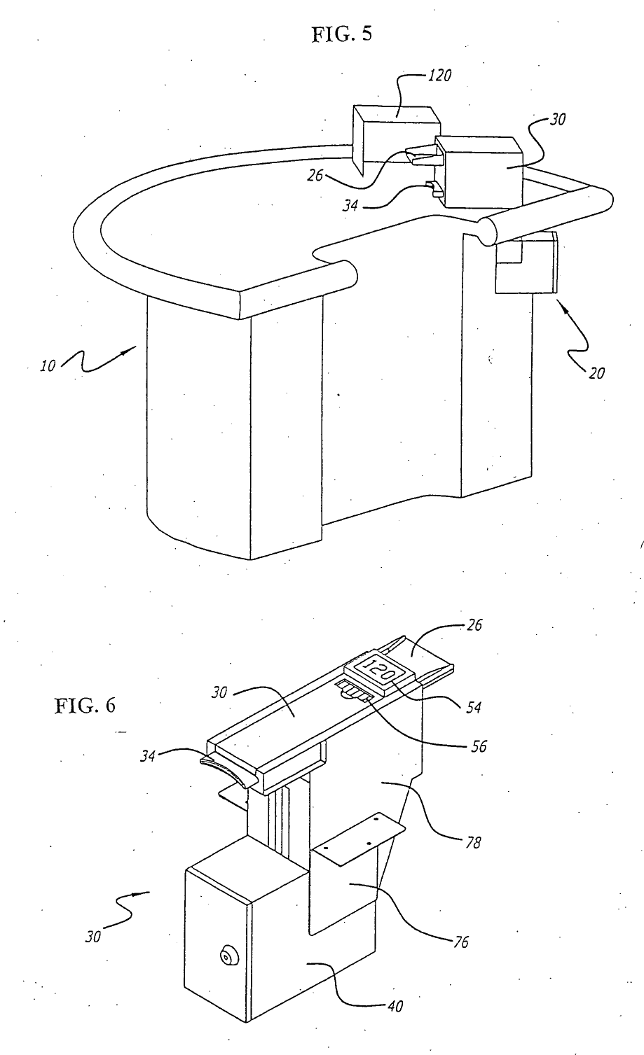

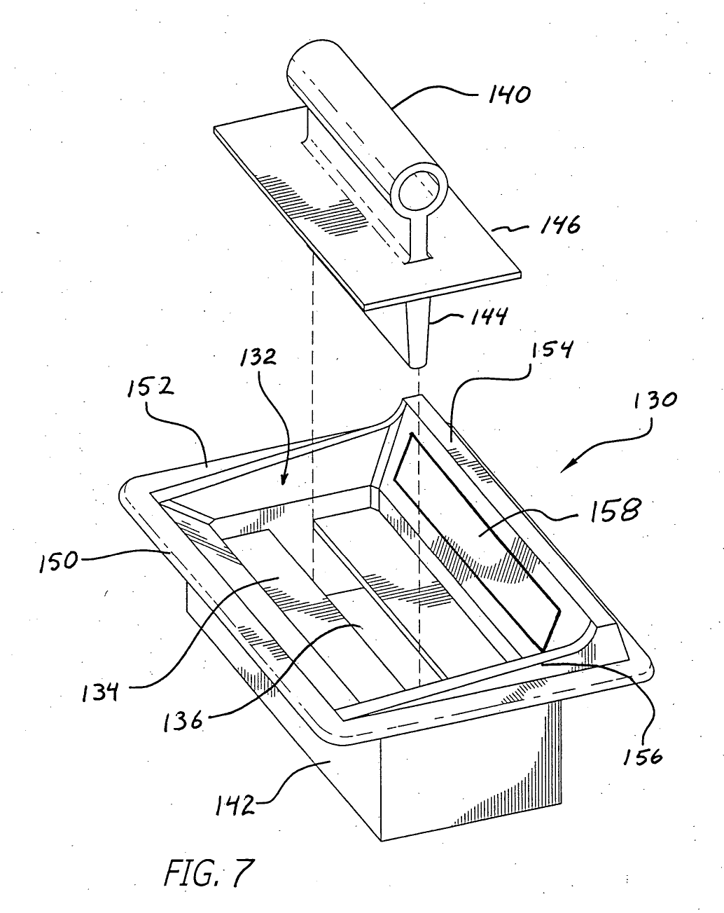

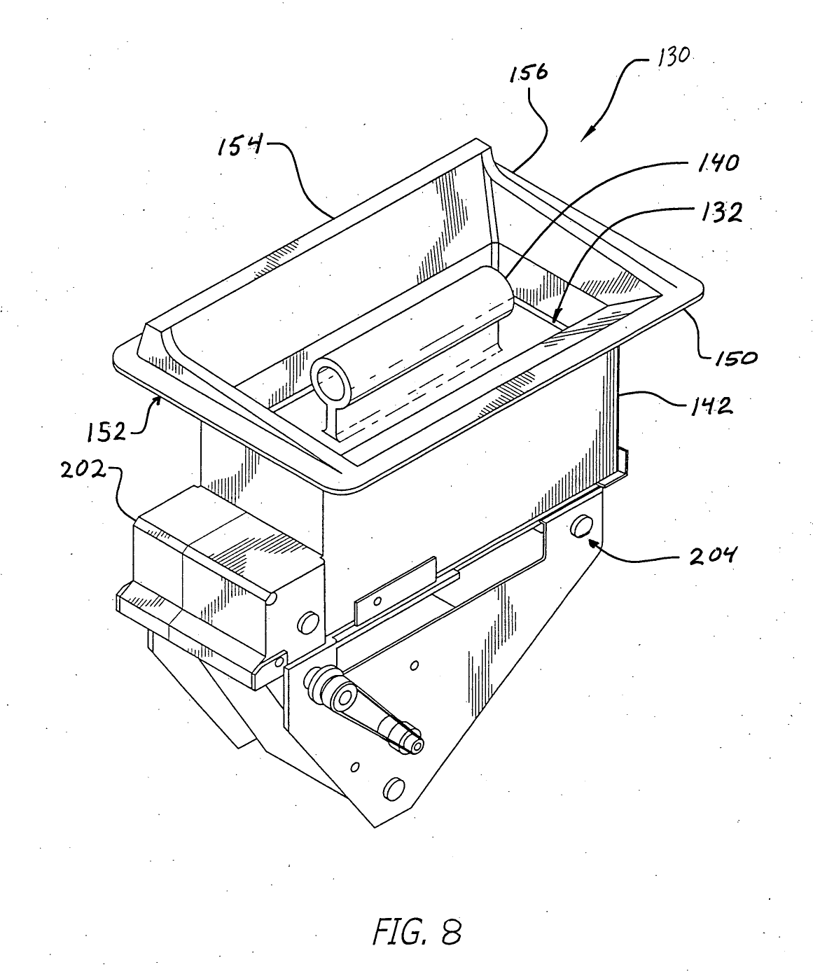

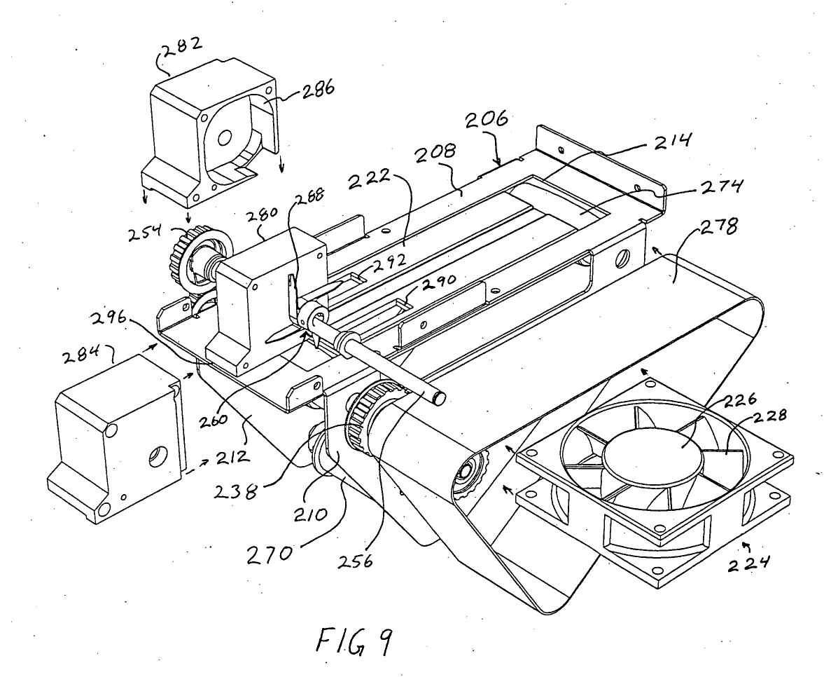

As illustrated in FIG. 4, the top of the narrow extension of the power assembly 42 includes a plurality of pin contacts 100 located extending from the power assembly 42 toward the validator assembly 30. The pin contacts 100 may be spring-loaded to maximize contact between the pin contacts 100 and contacts located on the base of the validator assembly 30. The pin contacts 100 and contacts on the validator assembly 30 are made of alloys that allow transfer of electrical power and data between the validator assembly 30 and the power assembly 42. Alternatively, pin contacts 100 may be used primarily to transfer power from the power assembly 42 to the validator assembly 30, whereas an optical coupling device 102 on the power assembly 42 communicates with an optical coupling device on the validator assembly 30 to transfer data information.

The pin contacts 100 are attached to a power supply and controller in the power assembly 42. A cable 10 can be provided to couple power to the power assembly 42 and also electrically couple the controller of the power supply 42 to a computer server (not shown) in the casino. Alternatively, wireless technology can be used to communicate information between the bill acceptor 20 and a computer server (not shown) in the casino.

As illustrated in FIG. 5, a bill guard 120 attaches to the gaming table 10 and is positioned near the bill acceptor 20. The bill guard 120 minimizes the possibility that a player could reach onto the gaming table and remove the notes as they were being fed into or rejected from the bill acceptor. The bill guard 120 can be made of a translucent material such as high impact plastic. The bill guard 120 will allow the dealer and players to watch the bills as they are inserted into or rejected from the validator assembly 30. The bill acceptor 20 depicted in FIG. 5 is an alternative embodiment, where the bezel 26 and the bill dispenser 34 are positioned on the same side of the validator assembly 30.

As depicted in an alternative embodiment in FIG. 6, the bill acceptor 20 is enclosed within an integrated housing 78 containing the cash box 40. To install the bill acceptor 20 on the gaming table 10, a hole is cut into the gaming table 10. The hole may need to be larger than the drop slot 18. The bill acceptor 20 is mounted through this hole such that the validator assembly 30 is above the playing surface 14 and the cash box 40 is below. Mounting members 76 are provided to secure the bill acceptor 30 to the gaming table 10. The internal components of the bill acceptor 30 in the exemplary embodiment, such as the transportation assembly 32, bill separator 36, and the bill discriminator 38, would be used in this alternative embodiment.

FIG. 7 illustrates a perspective view of an alternative note feeder 130 adapted to receive at least one note from the top side of a gaming table 10 and provide the at least one note to a validator assembly (not shown) located underneath the playing surface of the gaming table 10. The note feeder 130 may be used in a variety of applications such as in a check-out counter of a retail store in addition to uses within the gaming industry. In the gaming industry, the note feeder 130 is preferably provided on the gaming table 10 proximate the dealer station. The note feeder 130 has an open cavity 132 configured to receive at least one note or a stack of notes laid flat. The cavity 132 may be substantially rectangular and adapted to hold at least one note having a rectangular shape. Preferably, the cavity 132 is configured to hold a plurality of notes having the size of standard U.S. currency. The cavity 132, however, may be configured to hold a variety of other notes having different shapes and sizes.

The cavity 132 has a base 134 with an opening 136 positioned axially along the center of the base 134. The opening 136 is preferably sized and configured to allow the at least one note to be forced through the opening 136. The base 134 may have a planar surface relative to the table 10. Alternatively, the base 134 may have opposite sides that slope down towards the opening 136 to allow the notes placed on the base to be guided into the opening 136 when the notes are pushed into the opening 136 with a plunger 140.

The opening 136 may have a rectangular configuration formed within the center of the base 134. The length of the opening 136 may be substantially equal to the length of the elongated side of a rectangularly shaped note. The width of the opening 136 is preferably wide enough to allow a predetermined number of notes to be pushed through the opening 136. For instance, the width of the opening 136 may be wide enough to accept at least forty notes folded in half in addition to the width of a plunger 140. The opening 136 may have other configurations as well, such as an oval shape. A dealer may use the plunger 140 to push the notes through the opening 134 to deposit the notes into an escrow chamber 142 formed within the note feeder 130.

The plunger 140 may have an elongated edge 144 adapted to fit within the opening 134. The plunger 140 may also have a flange 146 sized so as to fit within the cavity 132 so that the flange 146 of the plunger 140 substantially covers the base 134 of the cavity 132 when the edge 144 is inserted into the opening 136.

Before inserting one or more notes into the cavity 132, a dealer may organize a stack of rectangular shape notes so that they are aligned relative to each other. The dealer may then insert the stack of notes into the cavity 132. Once the notes are placed within the cavity 132, the edge 144 of the plunger 140 is used to push the notes through opening 136, thereby causing the notes to fold along their longitudinal axis. After the notes pass through the opening 136, the notes are aligned and stacked within the escrow chamber 142.

The note feeder 130 installed on the gaming table 10 preferably has a rectangular base 134 surrounded by sides 150, 152, 154 and 156. The side 150 may include a top edge substantially flush with the top surface of the gaming table 10 to allow the dealer to easily slide the notes into the cavity 132. The sides 152, 154 and 156 rising from the base 134 of the cavity 132 are preferably slightly raised relative to the playing surface of the gaming table 10, acting as a “spill-guard” for beverages which may be accidentally spilled on the gaming table 10. Additionally, when the dealer attempts to place a stack of notes into the cavity 132, the dealer can feel for the raised sides 152, 154 and 156 to find the cavity 132 of the note feeder 130 provided within the top surface of the gaming table 10. The note feeder 130 can be designed so that the side 154 includes a display panel 158 adapted to display a variety of information such as the total amount and denominations of the notes inserted into the opening 136, and the working status of the note feeder 130 and validator assembly 30. The display panel 158 may be a light emitting diode (LED) display or liquid crystal display electronically connected to the validator assembly 30. Additional functionality of the display panel 158 is discussed below.

FIG. 8 is a perspective view showing the mounting relationship of the note feeder 130 on the transportation system, 203 without the gaming table 10. As discussed above, the validator assembly 30 is adapted to receive notes from the note feeder 130 via the transportation system 203 to authenticate each of the notes and store the notes in a cash box as discussed in U.S. Pat. No. 6,745,887, hereby incorporated by reference. The validator assembly 30 may have an inlet slot that is adapted to receive one note at a time fed width edge first. The validator assembly 30 is preferably located underneath the gaming table 10 to receive the notes along a predetermined orientation. The escrow chamber 142 of the note feeder 130 is configured to store or escrow the notes in the same predetermined orientation so that a width edge of the note may be fed into the inlet slot of the validator assembly 30. A picker assembly 202 is provided between the escrow chamber 142 and the validator assembly 30 of the note feeder 130 to assure that notes are selectively and sequentially pulled from the escrow chamber 142 and guide the notes into the inlet slot of the validator assembly 30.

Once the validator assembly 30 has processed the notes from the note feeder 130, a variety of information about the notes inserted into the note feeder 130 may be provided to the display panel 158. (FIG. 7) For instance, the validator may provide information about the total amount of notes inserted into the note feeder 130, different denominations of notes included in the stack of notes, and rejected notes, if any, from the stack of notes. In addition, the validator assembly may provide information about the working status of the note feeder 130 and the validator assembly 30. The validator assembly 30 may be also connected to a network within a casino so the dealers can be provided with instant messages through the display panel on each of the tables.

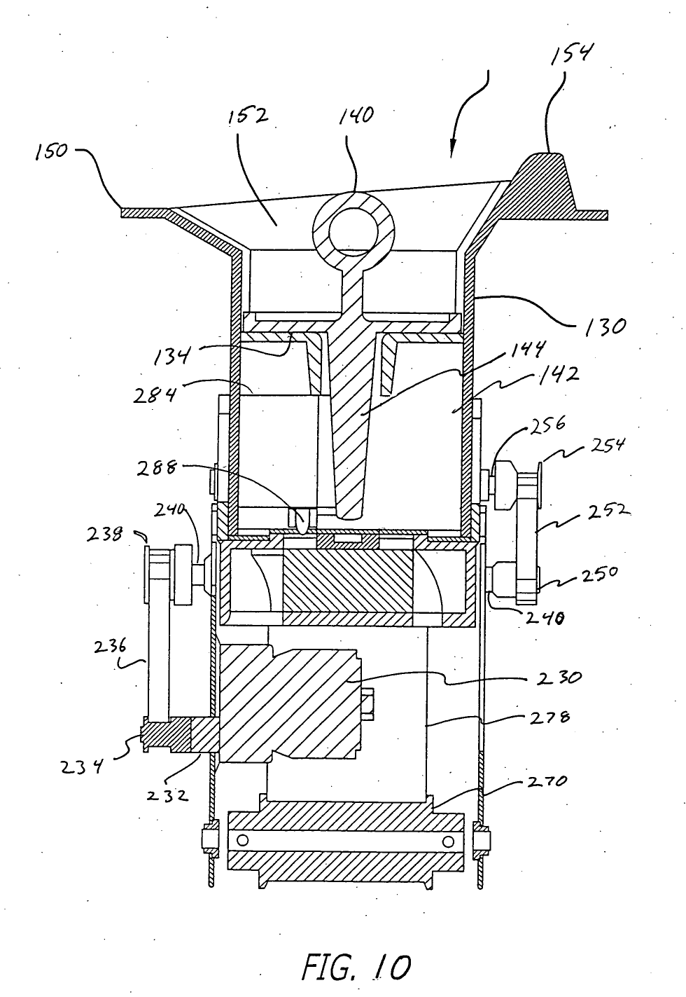

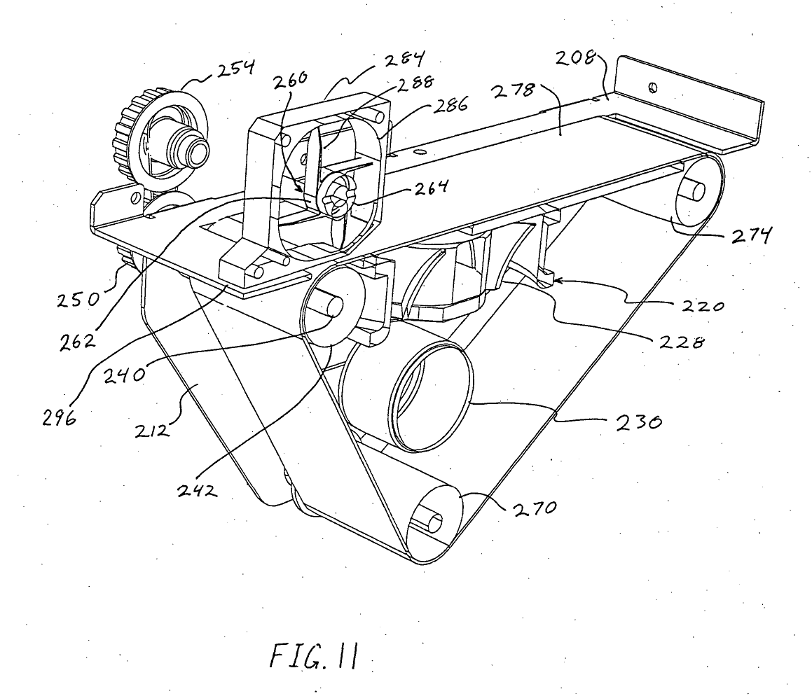

FIGS. 9 to 11 illustrate a transportation system 204 adapted to sequentially pass each of the notes from the escrow chamber 142 of the note feeder 130 to the inlet slot of the validator assembly 30. With the notes laying flat on the base of the escrow chamber 142, each of the notes may be fed sequentially from bottom to top into the validator assembly 30 by the transportation system 204.

The transportation system 204 for the note feeder 130 is best depicted in the perspective, cut away and exploded views of FIGS. 9 through 11. The transportation system 204 is built on a mounting bracket 206 having a top plate 208 and downward depending generally triangularly shaped side plates 210 and 212. The top plate 208 has a cutout 214. The transportation system includes a fan bracket assembly 220 which includes a fan bracket 222 and a fan assembly 224. The fan assembly 224 includes a fan motor 226 and fan blades 228. The fan bracket assembly 220 includes the fan bracket 222 having a generally planer surface which is mounted to the bottom side of the top plate 208 of mounting bracket 206, spanning the cutout 214 yet leaving openings at opposite ends of the fan bracket 222.

The transportation system 204 also includes a motor 230 connected via a shaft 232 to drive a pulley 234. A belt 236 wraps around the pulley 234 so as to drive a second pulley 238. The second pulley 238 is mounted on a shaft 240 extending all the way through both side plates 210, 212 of the mounting bracket 206. A belt drive roller 242 is mounted on shaft 240 in the location positioned between the respective side plates 210 and 212. At the opposite side of the mounting bracket 206, the shaft 240 extends outward to drive a timing pulley 250 which is connected via a timing belt 252 to drive a driven pulley 254 connected to a shaft 256 that extends back through side plate 212 and extending to the opposite side plate 210 of the mounting bracket 206. A hub assembly 260 is mounted at a mid point on the shaft 256. The hub assembly 260 includes a hub 262 and a hub plates 264.

A bottom belt roller 270 is mounted at the lower portion of the side plates 210 and 212 on a shaft 272 secured by bushings at the lower corners of the triangular side plates 210 and 212. A rear belt roller 274 is mounted on a shaft 276 and mounted in bushings at the rear corners of triangular side plates 210 and 212. A conveyor belt 278 is configured to wrap around the belt drive roller 242, bottom belt roller 270 and rear belt roller 274 and to extend up through the openings formed at the respective ends of the fan mounting bracket 222 and the mounting bracket top plate 208, whereby the belt runs over the top surface of the fan bracket 222 driven by belt drive roller 242.

At the forward edge of the transportation system 204 is the picker assembly 202. The picker assembly includes a center section 280, left side 282 and right side 284. Within at least one of the sides 282 or 284 there is a cavity 286 which accommodates a picker wheel 298. The picker wheel 288 incorporates the hub 262 and the blades 264. These components are mounted on the shaft 256 so as to rotate in the opposite direction as the direction that the conveyor belt 268 rotates when a bill is being transported out of the reservoir 142 by the transportation system 204. The counter rotation of the hub blades 264 prevents multiple bills from passing from the reservoir 142 stacked one on top of the other.

As noted above, the fan bracket assembly 220 includes a fan bracket 222 forming a plate over which the conveyor belt 278 traverses. The lowermost note in the reservoir 142 lays atop the upper surface of the conveyor belt 278. The fan bracket 222 includes slots 290, 292 and the conveyor belt 278 may be made from a porous material whereby the note lying atop the conveyor belt 278 is sucked down towards the belt by the operation of the fan assembly 224 and air passing through the openings 290, 292 of the fan bracket 222. The fan motor 226 and belt drive motor 230 are both electrically connected to the validator 30 to obtain power and processing control signals therefrom. Thus, when the transportation system 204 is activated, the fan motor 226 and belt drive motor 230 are both powered, one to adhere notes to the conveyor belt 278 and the second to drive the conveyor belt 278, and the validator 30 is also activated to accept and process the notes being provided.

The transportation system 204 operates to selectively feed one note at a time from the escrow chamber 142 across the top of the conveyor belt 278 towards an outlet slot 296 so that the note may pass to the intake slot of the validator 30. The motor 230 drives the shaft 232 and thereby the timing pulley 234 which in turn drives the belt 236 driving the timing pulley 238 and shaft 240. The belt drive roller 242 mounted on shaft 240 frictionally engages the conveyor belt 278 thereby driving the conveyor belt 278. The opposite end of shaft 240 also rotates, rotating the timing pulley 250 and the timing belt 252 to drive the driven pulley 254 and shaft 256. The rotation of shaft 256 is counter-rotating with respect to the shaft 240 on which the belt drive roller 242 is mounted and so the shaft 256 having the hub assembly 260 and more particularly the hub blades 264 rotates in a counter direction with respect to the direction of the movement of the conveyor belt 268. By this configuration, one note at a time is extracted from the reservoir of 142 to be sequentially fed into the validator 30, and the transportation system 204 can rapidly move a stack of notes from the escrow chamber 142 to the validator 30.

In the validator 30, as discussed above, information concerning the authenticity and denomination of each note is passed to the validator processor 50 (discussed above) which is also preferably connected to a central computer or server of the casino. Upon receipt of a note or a series of notes and determination of their authenticity, a signal is sent to the casino processor or server signifying receipt as well as the denomination of the notes. The value of the notes accepted by the validator assembly 30 can also be displayed individually, sequentially or cumulatively totaled on the display panel 158, which is electrically interconnected to the validator processor 50.

From the foregoing detailed description, it will be evident that there are a number of changes, adaptations and modifications of the present invention which come within the province of those skilled in the art. The scope of the invention includes any combination of the elements from the different species or embodiments disclosed herein, as well as subassemblies, assemblies, and methods thereof. However, it is intended that all such variations not departing from the spirit of the invention be considered as within the scope thereof.

1. A note feeder operative to feed notes to a validator assembly, the note feeder capable of receiving a stack of notes, the note feeder comprising:
a note receiver adapted to be mounted on a tabletop, said note receiver defining a cavity sized to accept notes arranged in a determined orientation;
an opening at the bottom of the cavity to allow notes placed in the cavity to be directed through the opening;
an escrow chamber positioned below said cavity and sized to receive a stack of notes passed through the opening and arranged in the determined orientation; and
a transportation system to sequentially feed notes from said escrow chamber to the validator assembly.

2. The note feeder of claim 1, wherein said transportation system includes a belt drive motor and a conveyor belt, the conveyor belt including a section passing over a bottom portion of said escrow chamber and, when driven by said motor, operative to sequentially transport the notes from within said escrow chamber to said validator assembly along a predetermined pathway.

3. The note feeder of claim 1, wherein the note receiver cavity is defined by four sides rising from a base, at least one of said four sides rising above the plane of the top surface of the tabletop.

4. The note feeder of claim 3, wherein at least one of the four sides has an upper edge terminating at the plane of the top surface of the tabletop.

5. The note feeder of claim 1, wherein the note receiver cavity has a rectangular configuration adapted to receive a stack of notes.

6. The note feeder of claim 3, wherein at least one of said four sides of said note receiver cavity includes a visual display.

7. The note feeder of claim 6, wherein said visual display is electrically connected to said validator assembly to receive and display information provided by said validator assembly.

8. The note feeder of claim 1, wherein the escrow chamber is sized to receive and sequentially process a stack of at least twenty notes.

9. The note feeder of claim 1, wherein the transportation system includes a picker assembly to prevent multiple notes from being simultaneously passed to said validator assembly.

10. A note feeder, built into a top surface of a table, for receiving at least one note and passing the at least one note to a validator assembly located underneath the table, the note feeder comprising:
a cavity configured to receive at least one note from a top side of said table, the cavity having a base with an opening therein to allow the at least one note to pass through to an escrow chamber designed to receive the at least one note passed through the opening, the escrow chamber located beneath the level of the top side of the table; and
a transportation system to sequentially pass the at least one note from said escrow chamber to a validator assembly to authenticate the at least one note, the validator assembly located adjacent to the escrow chamber and underneath the table.

11. The note feeder of claim 10, wherein said transportation assembly further comprises:
a conveyor belt to transport notes; and
a fan assembly to cause a note lying on said conveyor belt to advance with the advancement of said conveyor belt.

12. The note feeder of claim 11, wherein said transportation assembly further comprises:
a picker assembly to prevent multiple notes from advancing while stacked atop another note on said conveyor belt.

13. The note feeder of claim 11, wherein said transportation assembly further comprises:
a motor and drive assembly to drive said conveyor belt.

14. The note feeder of claim 13, wherein said drive assembly comprises:
a drive shaft extending from said motor, a pulley mounted on said drive shaft, a belt mounted on said pulley, a driven pulley mounted on a drive roller shaft, said driven pulley being driven by said belt, and a conveyor belt drive roller mounted on said drive roller shaft; and
at least one conveyor belt roller to guide the path of said conveyor belt.

15. The note feeder of claim 10, wherein the cavity is adapted to receive notes arranged in a predetermined orientation, said escrow chamber adapted to temporarily store the notes in a corresponding predetermined orientation, and said transportation system configured to pass the notes along a predetermined pathway into said validator.

16. The note feeder of claim 11, wherein said transportation assembly further comprises:
A fan mounting assembly including a mounting bracket having at least one hole there through positioned above said fan, said mounting bracket supporting a portion of the pathway of said conveyor belt.

17. The note feeder of claim 10, further comprising:
A plunger operative to force said at least one note through said opening at said base of said cavity.

18. A system capable of receiving at least one note from a top side of a table and feeding the at least one note to a validator located underneath the table, the system comprising:
a bulk note feeder having a cavity adapted to receive a plurality of notes from a top side of a table, the cavity having an opening configured to allow the plurality of notes to pass therethrough;
an escrow chamber adapted to receive the plurality of notes passed through the opening and store the plurality of notes underneath the table;
a validator located underneath the table and adapted to authenticate the at least one note; and
a transportation system adapted to pass the at least one note from the escrow chamber to the validator.

19. The system according to claim 18, wherein the escrow chamber has a base and an outlet, and said transportation system includes a belt, said belt adapted to pass over said base of said escrow chamber and transport each of the plurality of notes from within the escrow chamber through said outlet to the validator assembly along a longitudinal axis of the plurality of notes.

20. The system according to claim 18, wherein said validator further comprises:
a note acceptor; and
a cash box for storing accepted noted

21. The system according to claim 20, wherein said escrow chamber is sized to accept and process a stack of at least twenty notes.

22. The system according to claim 18, further comprising:
a display on said bulk note feeder cavity, said display connected to said validator to receive and display information concerning notes processed by said validator.

23. The system according to claim 18, wherein said transportation system includes a fan configured to aid the passage of said notes from said cavity of said bulk note feeder through said escrow chamber to said validator.

24. The system according to claim 18, further including a plunger having an elongated protrusion edge adapted to fit within said opening to push the plurality of notes through said opening.

25. The system according to claim 24, wherein said plunger has a flange adapted to fit within said cavity to protect the opening against liquids and objects inadvertently falling into the opening.

26. A method of processing a stack of notes received in a bulk note feeder, the method comprising:
receiving a stack of notes in a cavity formed into a top side of a table;
passing the stack of notes through an opening in the cavity to an escrow cavity underneath the top of the table;
temporarily storing the stack of notes underneath the table in said escrow cavity; and
sequentially transporting each of the notes to a validator located underneath the table for authenticating each of the notes.

27. A method of authenticating a plurality of notes received on a table, the method comprising:
stacking a plurality of notes so that the notes are aligned;
placing the plurality of notes into a cavity formed within a table along a predetermined orientation, the cavity having an opening;
pushing the plurality of notes through the opening to an escrow chamber underneath the top of the table;
authenticating each of the plurality of notes underneath the table; and
storing the authenticated notes within a predetermined area located underneath the table.
